(19) United States
(12) Patent Application Publication
(10) Pub. No.: US 2006/0267310 A1
(43) Pub. Date: Nov. 30, 2006

(54) Hitch alignment method and apparatus

(76) Inventor: Kenneth P. Richardson, Lander, WY (US)

Correspondence Address: FOGG AND ASSOCIATES, LLC, P.O. BOX 581339, MINNEAPOLIS, MN, 55458-1339, US

(21) Appl. No.: 11/138,839

(22) Filed: May 26, 2005

(51) Int. Cl. B60D 1/36

(52) U.S. Cl. 280/477

(57) ABSTRACT

Systems and methods for aligning trailer hitches are provided. A method for aligning a tow vehicle having a trailer hitch receiver to a trailer having a hitch pin compatible for use with the trailer hitch receiver comprises mounting an alignment device to the tow vehicle; observing the alignment of a mast section of the alignment device with the hitch pin; visually aligning the mast section of the alignment device with the hitch pin; and adjusting the relative position of the tow vehicle with respect to the trailer while backing the tow vehicle towards the trailer to keep the mast section aligned with the hitch pin.

### TECHNICAL FIELD

The following description relates generally to trailer hitches and more specifically to systems and methods for aligning tow vehicles with trailers.

### BACKGROUND

The coupling of a tow vehicle to a towed unit is frequently accomplished through the use of hitch known as a fifth wheel hitch system (hitch system). The first part of the hitch system consists of a steel receiver assembly that is mounted in the back of an open bed truck such as a pickup truck. This portion of the hitch assembly is generally removable from the truck bed and consists of a slotted plate assembly on pivot and rotating sub assemblies. The second part of the hitch system is at the front of the towed unit (trailer) and is usually an integral portion of the towed unit frame; this portion of the hitch system comprises a steel peg that slips into the slotted receiver on the truck. This type of hitch system is commonly used in the joining of a pickup truck to a recreational or farm type trailer.

The use of this hitch system requires backing the truck towards the trailer with a reasonable degree of lateral accuracy so that the steel peg will slip into the slot on the receiver. One of the problems inherent in this system is that many farm and recreational users do not posses the physical skill or attributes to consistently accomplish the mating of these two components of the hitch system. To aid in the backing of the truck to the trailer, trailer hitch manufacturers often apply a decal of an arrow to the backside of the truck's portion of the hitch to aid the driver to properly align the truck to the trailer unit. This decal is meant to be seen through the rear view window of the truck and act as a visual guide to aid the driver in aligning the truck to the trailer in a reasonably accurate manner.

The problem with the manufactures' decal is that while a driver attempts to align the truck to the trailer, the driver can only see the decal in the overhead rear view mirror or by looking directly out of the back window of the truck. To accomplish the latter, the driver must physically turn in the seat. The placement of the decal on the backside vertical portion of the tow vehicle hitch makes it difficult for a person of short stature to see in the overhead rear view mirror without either rising up in the seat or sitting on a bolster. Physically turning in the seat to observe the location of the decal generally makes it difficult for a person of any stature to safely back the truck into place. Additionally, when cargo is placed between the truck's portion of the hitch and the rear view window the decal becomes more difficult or impossible to see regardless of the driver's physical stature. Because the decals are generally made of paper, they tend to fade, wear out, or become torn which causes them to diminish in usability. It was because of these limitations in the manufactures' truck/trailer alignment system that the present invention was first conceived.

For the reasons stated above and for other reasons stated below which will become apparent to those skilled in the art upon reading and understanding the present specification, there is a need in the art for improved systems and methods for aligning hitch systems.

### SUMMARY

The Embodiments of the present invention provide systems and methods for trailer hitch alignment, and will be understood by reading and studying the following specification.

In one embodiment, a device to aid the aligning and coupling of a tow vehicle having a trailer hitch receiver, to a trailer having a hitch pin compatible for use with the trailer hitch receiver, is provided. The device comprises a positionable base section, and a mast section having an aligning end and a mounting end. The mounting end is secured to the positionable base section. The positionable base section is adapted to support the aligning end in a viewable position when the device is positioned on the tow vehicle.

In another embodiment, a method for aligning a tow vehicle having a trailer hitch receiver, to a trailer having a hitch pin compatible for use with the trailer hitch receiver is provided. The method comprises mounting an alignment device to the tow vehicle, observing the alignment of a mast section of the alignment device with the hitch pin, visually aligning the mast section of the alignment device with the hitch pin, and adjusting the relative position of the tow vehicle with respect to the trailer while backing the tow vehicle towards the trailer to keep the mast section aligned with the hitch pin.

In yet another embodiment, a tow vehicle adapted to be coupled with a trailer is provided. The vehicle comprises means for coupling the tow vehicle to the trailer; means for visually aligning the means for coupling the tow vehicle to the trailer with a means for coupling the trailer to the tow vehicle, wherein the means for visually aligning includes an aligning end and a mounting end; and means for securing the mounting end of the means for visually aligning, wherein the means for securing is adapted to support the aligning end of the means for visually aligning in a position viewable from the rear view mirror of the tow vehicle.

### DRAWINGS

The present invention can be more easily understood and further advantages and uses thereof more readily apparent when considered in view of the detailed description and the following figures in which:

FIGS. 1A, 1B and 1C are top view diagrams illustrating the alignment of a tow vehicle with trailer using one embodiment of the present invention;

FIGS. 2A, 2B, 2C and 2D illustrate alignment devices of one embodiment of the present invention;

FIGS. 3A and 3B illustrate an alternative base section of one embodiment of the present invention;

FIGS. 4A and 4B illustrates alternate embodiments of an alignment device of the present invention;

FIG. 5 is a flow chart illustrating a method of one embodiment of the present invention; and

FIGS. 6A and 6B illustrate alternative mast sections of embodiments of the present invention.

In accordance with common practice, the various described features are not drawn to scale but are drawn to emphasize features relevant to the present invention. Reference characters denote like elements throughout Figures and text.

### DETAILED DESCRIPTION

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense.

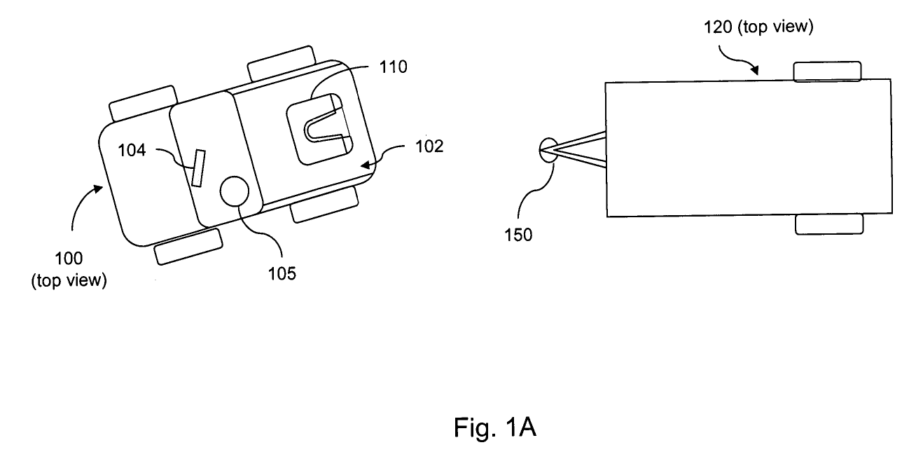

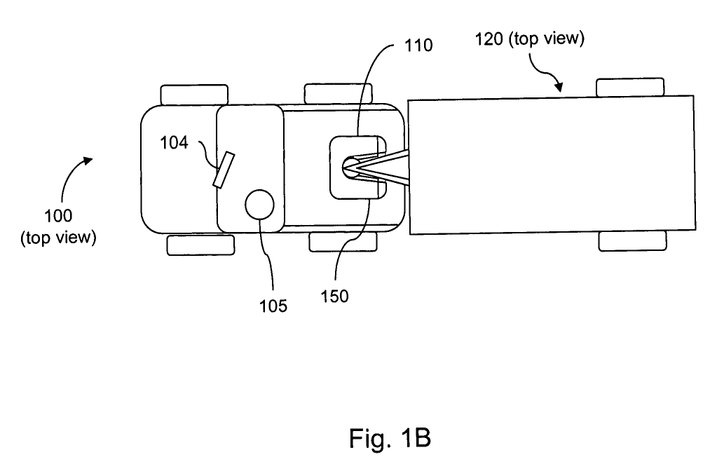

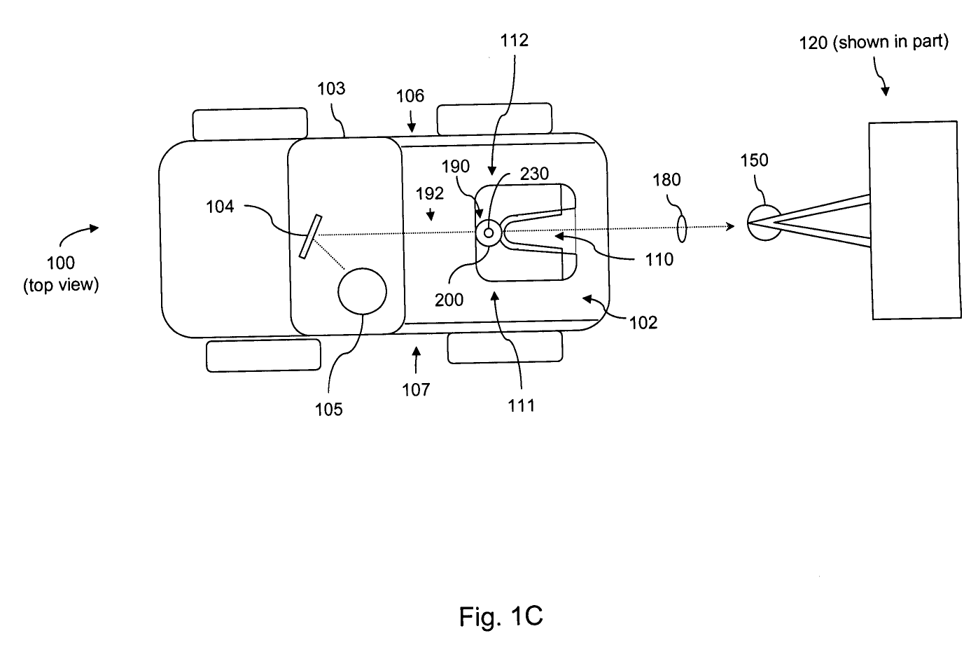

As illustrated in FIGS. 1A and 1B, embodiments of the present invention assist the driver 105 of a tow vehicle 100 (such as a truck or other vehicle typically utilized for towing) having a fifth wheel hitch receiver 110 to accurately guide tow vehicle 100 towards a trailer 120 having a fifth wheel pin assembly (pin) 150 so that the two units may be coupled.

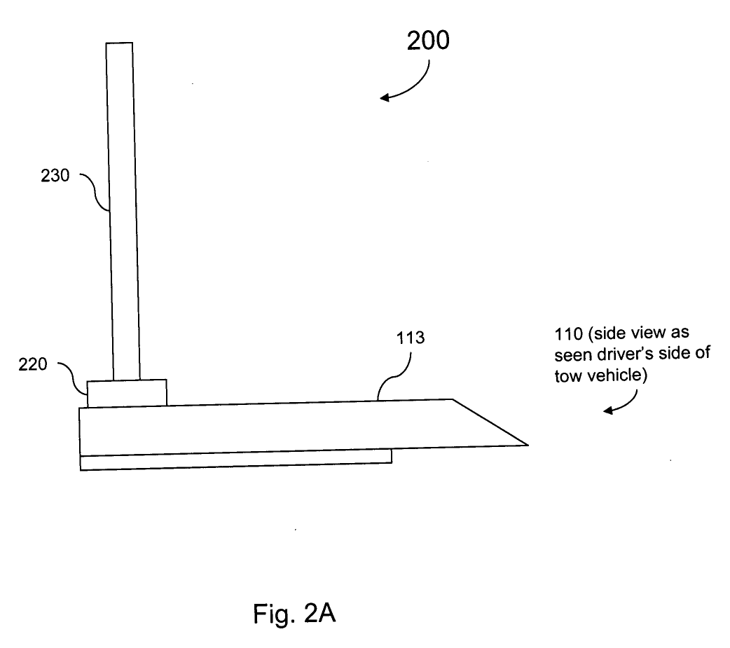

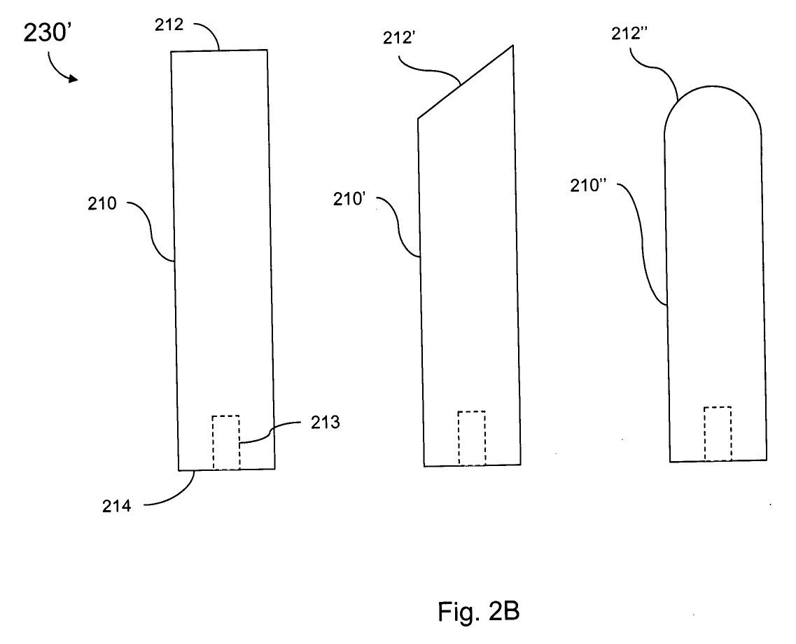

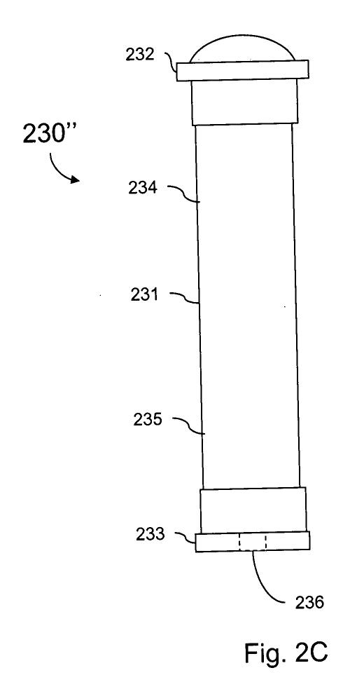

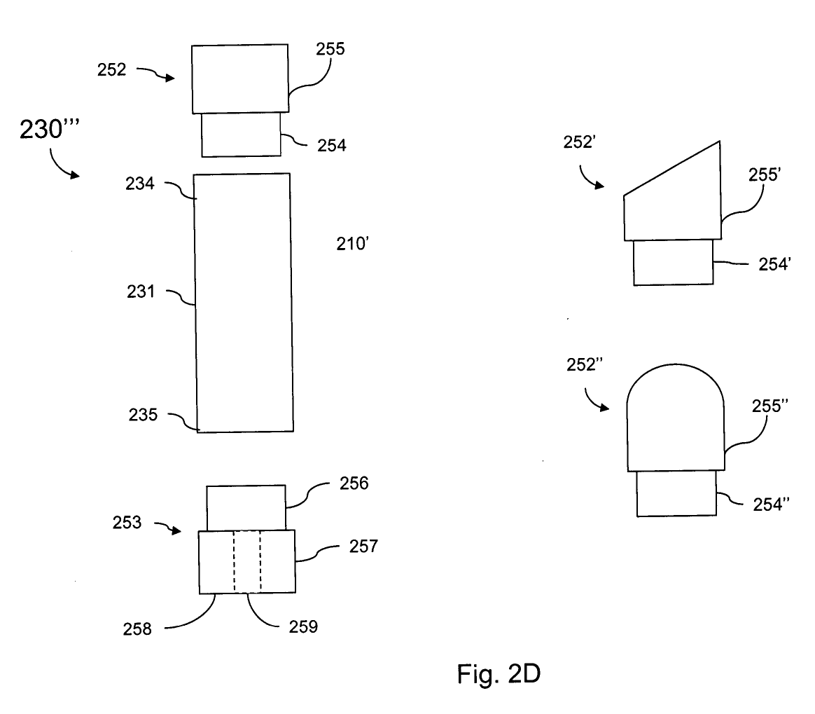

Illustrated in FIG. 2A, embodiments of the present invention include an alignment device 200 which is adapted to project above a receiving plate surface 113 of a hitch receiver 110 so as to be readily seen from the rear view mirror 104 of a tow vehicle regardless of whether cargo is carried in the tow vehicle's cargo bed. Alignment device 200 is advantageous over the existing art because it is easily seen in the rear view mirror by most drivers, regardless of the physical stature of the driver, is highly visible against a variety of backgrounds, is resistant to weather, and is moveable. Additionally, embodiments of the present invention do not require drilling or other modification to hitch receiver 110, tow vehicle 100, pin 150, or trailer 120. In one embodiment, alignment device 200 comprises base section 220 and mast section 230. Mast section 230 comprises a wand which is supported in place (above receiving plate surface 113 so as to be viewable from rear view mirror 104) by base section 220. Base section 220 is adapted to hold mast section 230 in place, and in a viewable position, when attached either to the floor of cargo bed 102 of a tow vehicle 100 or to hitch receiver 110.

FIGS. 2B, 2C and 2D illustrate three separate examples for constructing a mast section 230. In one embodiment illustrated in FIG. 2B, a mast section 230′ comprises a cylindrical mold cast member 210 made of a plastic, plastic like resins, or similar material. In one embodiment, the mounting end 214 of mast section 230′ has a pilot hole 213 either formed or drilled into member 210 to facilitate the use of a screw for assembly with base section 220. In other embodiments, members 210′ and 210″ comprise the elements of member 210 wherein aligning ends 212′ and 212″ of mast section 210′ and 210″ are adapted to shed water. Aligning end 212′ of member 210′ is angled to allow water to shed. In embodiment, aligning end 212″ of member 210″ is rounded to shed water. The exact length and diameter of member 210 and pilot hole 213 is readily determined by one skilled in the art based on the requirements of the specific application. In one embodiment, member 210 is a mold cast member of approximately ⅜″ (0.375″) to ½″ (0.50″) in diameter. In one embodiment, pilot hole 213 is approximately 9/64″ (0.141″) in diameter and 1″ deep. The axis of pilot hole 213 aligns with the axis of member 210 to facilitate mounting with base section 220. In one embodiment, member 210 is cast with a plastic material colored to increase visibility when seen against various backgrounds. In one embodiment, member 210 is painted, colored, or otherwise marked in such a way that it is readily discernable when viewed against various backgrounds, such as, but not limited to, the pin 150 area of trailer 120, plants, campgrounds, parking lots, loading docks, and buildings.

In one embodiment illustrated in FIG. 2C, a mast section 230″ comprises a shaft member 231 adapted with an aligning end cap 232 and a mounting end cap 233 respectively affixed to an aligning end 234 and mounting end 235 of shaft member 231. In one embodiment, shaft member 231 comprises a length of commercially available Poly Vinyl Chloride (PVC) or Chlorinated Poly Vinyl Chloride (CPVC) water line material. In one embodiment, the aligning end cap 232 comprises a commercially available PVC or CPVC rounded end cap. In one embodiment, mounting end cap 233 comprises a commercially manufactured PVC or CPVC flat end cap. In one embodiment, mounting end cap 233 is drilled to form a pilot hole 236 to facilitate the use of a screw, a nut and bolt, or similar fastener for assembly with base section 220.

As discussed above, the exact length and diameter of shaft member 231 and pilot hole 236 is readily determined by one skilled in the based on the requirements of the specific application. In one embodiment, shaft member 231 is ½″ nominal diameter PVC or CPVC water line material, and aligning end cap 232 and mounting end cap 233 are comprised of a ½″ nominal PVC or CPVC rounded end cap and a ½″ nominal PVC or CPVC flat end cap, respectively. In one embodiment, pilot hole 236 has a diameter of 9/64″ (0.141″). In one embodiment, aligning end cap 232 and mounting end cap 233 are affixed to shaft member 231 using an adhesive such as, but not limited to, commercially available PVC and CPVC cement. In one embodiment, mast section 230 is painted, colored, or otherwise marked in such a way that it is readily discernable when viewed against various backgrounds, such as, but not limited to, the pin 150 area of trailer 120, plants, campgrounds, parking lots, loading docks, and buildings.

In one embodiment, illustrated in FIG. 2D, mast section 230′″ comprises shaft member 231 adapted with an aligning end cap 252 and a mounting end cap 253 respectively affixed to an aligning end 234 and mounting end 235 of shaft member 231. In one embodiment one or both of aligning end cap 252 and mounting end cap 253 comprise solid mold cast members made of plastic, plastic like resins, or similar material. In one embodiment, aligning end cap 252 further comprises an inserting end 254 adapted to be inserted into the aligning end 234 of shaft member 231. In one embodiment, inserting end 254 is shouldered in to a diameter of approximately 1/32″ (0.03″) less than the inside diameter of shaft member 231 so that it can be inserted into the aligning end 234 of shaft member 231. In one embodiment, aligning end cap 252 further comprises a visible end 255 having a diameter greater than or equal to the outside diameter of shaft member 231. In one embodiment, to enhance the overall visual appeal of mast section 230, visible end 255 is cast with a diameter that matches the outer diameter of shaft member 231. Aligning end caps 252′ and 252″ comprise the elements of aligning cap 252 wherein aligning end caps 252′ and 252″ are adapted to shed water. In one embodiment, visible end 255′ of end cap 252′ is angled to allow water to shed. In one embodiment, visible end 255″ of end cap 252″ is rounded to shed water.

In one embodiment, mounting end cap 253 further comprises an inserting end 256 adapted to be inserted into the mounting end 235 of shaft member 231. In one embodiment, mounting end cap 253 is adapted to be inserted into the mounting end 235 of shaft member 231. In one embodiment, inserting end 256 is shouldered in to a diameter of approximately 1/32″ (0.03″) less than the inside diameter of shaft member 231 so that it can be inserted into the aligning end 234 of shaft member 231. In one embodiment, mounting end cap 253 further comprises a visible end 257 having a diameter greater than or equal to the outside diameter of shaft member 231. In one embodiment, to enhance the overall visual appeal of mast section 230′″, visible end 257 is cast with a diameter that matches the outer diameter of shaft member 231. In one embodiment, mounting end cap 253 is formed with a flat bottom surface 258 and pilot hole 259 either formed or drilled through the solid material to facilitate fastening with base section 220. In one embodiment, pilot hole 259 is 9/64″ (0.141″) in diameter. In one embodiment, aligning end cap 252 and mounting end cap 253 are affixed to shaft member 231 using an adhesive such as, but not limited to, commercially available contact cement or other suitable glue. In one embodiment, mast section 230′″ is painted, colored, or otherwise marked in such a way that it is readily discernable when viewed against various backgrounds, such as, but not limited to, the pin 150 area of trailer 120, trees, campgrounds, parking lots, loading docks, and buildings.

Utilization of PVC or CPVC plastic water line material to construct shaft member 231 (as described in FIGS. 2B and 2C) makes the manufacture of various lengths for mast section 230 more economically feasible than the totally cast option provided in FIG. 2A. Additionally, PVC and CPVC are inherently light color and have favorable weather resistant properties. The use of solid mold cast end caps, such as aligning end cap 252 and mounting end cap 253, streamline the overall appearance of alignment device 200, making it more attractive to potential purchasers. The choice of using CPVC or PVC in the manufacture of the shaft member 231 depends upon the specific length of mast section 230 to be manufactured. Standard CPVC water pipe material has an outside diameter of approximately ⅝″ (0.625″) and is better suited for use for a shorter length mast section 230 while PVC water pipe material has an standard outside diameter of approximately 27/32″ (0.835″) and is better suited for use for a longer mast section 230.

It is foreseen by the inventor that alignment device 200 will be manufactured with several lengths of mast section 230 available, or alternately with an adjustable length mast section 230. The choice of the exact lengths and method of manufacture is a market driven decision. A user will have the option of purchasing an alignment device 200 with the best mast section 230 length to suit the user's specific needs and applications. The size and locations of cargo carried in cargo bed 102, the distance from the hitch receiver 110 to rear window 103 of tow vehicle 100, and the skill of driver 105 are factors that a purchaser will need to consider prior to purchasing an alignment device 200 of a particular height.

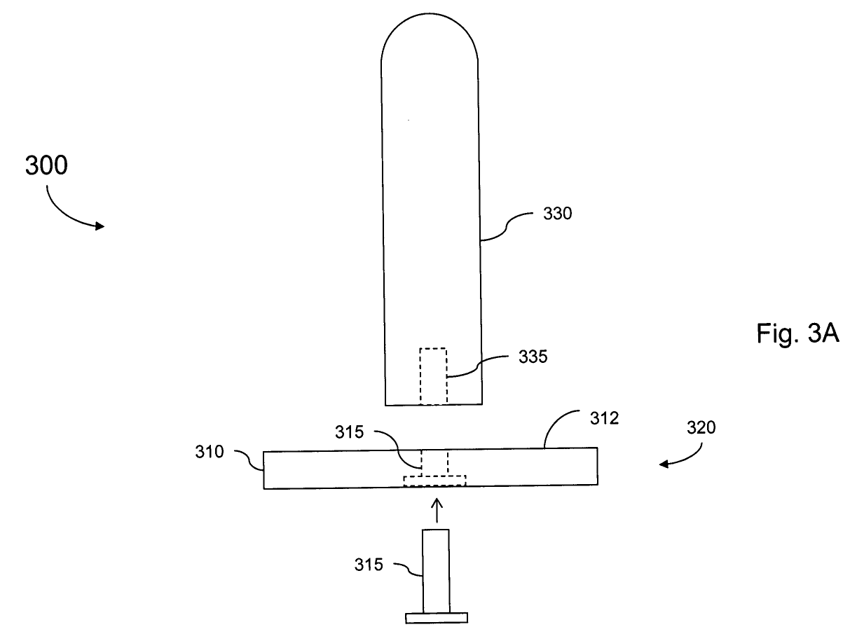

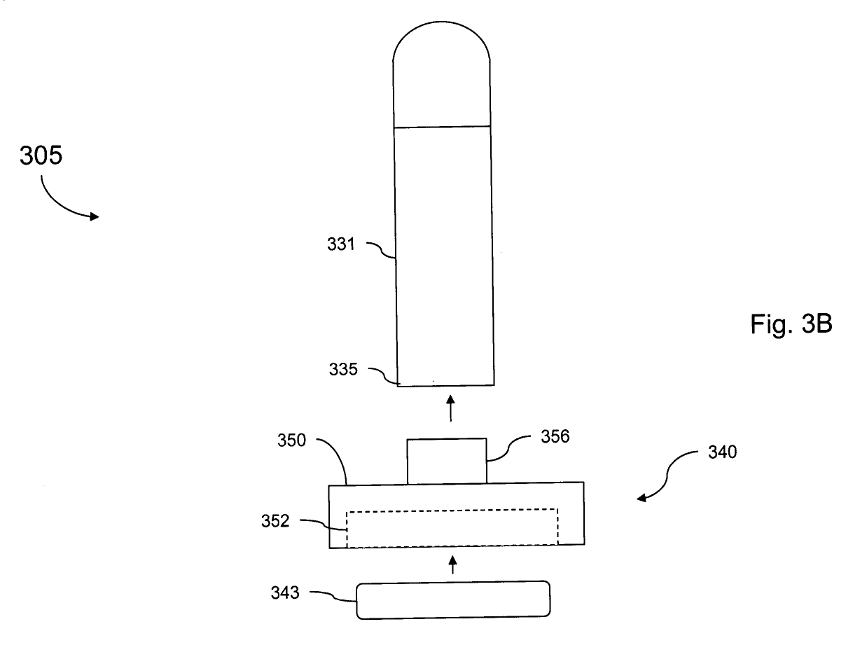

FIG. 3A illustrates one embodiment 300 of a base section 220 as illustrated in FIG. 2A. As discussed above, base section 220 functions to provide physical support to maintain mast section 230 in a position viewable from the overhead rear view mirror 104 of tow vehicle 100 while securing alignment device 200 to either cargo bed 102 or hitch receiver 110 of tow vehicle 100. In one embodiment, a base section 320 comprises a flat platform 310 adapted to secure to a mast section 330. In one embodiment, mast section 330 is secured to the top side 312 of platform 310 through an adhesive such as, but not limited to, a glue, contact cement, an epoxy adhesive, or similar bonding agent. In one embodiment, mast section 330 is secured to the top side 312 of platform 310 by a fastener 315 such as, but not limited to, a screw, a nut and bolt, a pin, a threaded stud, or similar fastening mechanism. In one embodiment, platform 310 is adapted with a recessed pilot hole 313 to facilitate mounting platform 310 to a mast section 330 using fastener 315. In one embodiment, fastener 315 is a screw inserted into pilot hole 313 and mast section 330 pilot hole 335 (such as pilot holes 213, 236 and 259) and tightened to secure base section 320 to mast section 330.

In one embodiment, platform 310 comprises a magnetic material having sufficient magnetic strength to hold mast section 330 in a viewable position while securing alignment device 200 to either cargo bed 102 or hitch receiver 110 of tow vehicle 100 while tow vehicle 100 is in motion. The advantage of using a magnet to hold alignment device 200 in place is that a magnet allows the device to be fitted to most all fifth wheel hitch assemblies or tow vehicles without the use of tools or adhesives. A user can position alignment device 200 without physically modifying tow vehicle 100 or hitch receiver 110. A magnetic platform 310 assures that an alignment device 300 can be placed where it will best suit the needs of the user. A magnetic platform 310 allows the user to quickly remove alignment device 300 from tow vehicle 100 when it is not needed and to move it from vehicle to vehicle. Further, if alignment device 300 is dislodged from hitch receiver 110 at any time during the hitching operation or during transport, the magnetic platform 310 will engage steel parts of the hitch assembly or truck bed so that alignment device 300 will not be lost. As would be appreciated by one skilled in the art upon reading this specification, the selection of magnetic material for use in constructing base section 320 is a function of the mass and height of mast section 330 and is readily determined by one skilled in the art without undue experimentation. In one embodiment, base section 320 comprises a flat disk shaped magnetic, part number 07216 manufactured by Master Magnetics Incorporated of Castle Rock, Colo., or similar product.

FIG. 3B illustrates one embodiment 305 of an alternate base section 340, integrating a magnetic material 342 directly into a solid mold cast mounting end cap 350. End cap 350 comprises an inserting end 356 adapted to be inserted into mounting end 335 of a shaft member 331 (such as shaft member 231 described in FIG. 2C). In one embodiment, mounting end cap 350 further comprises an impression 352 to facilitate the insertion of magnetic material 343. In one embodiment, end cap 350 is a molded solid material and impression 352 is a circular impression approximately 19/32″ (0.59″) in diameter and ⅛″ deep formed into the solid material. In one embodiment, magnetic material 342 is placed into circular impression 352 so that approximately 1/16″ of the magnet protruding from base section 340. In one embodiment, magnetic material 343 is secured in place by an adhesive such as contact cement, glue, or similar produce.

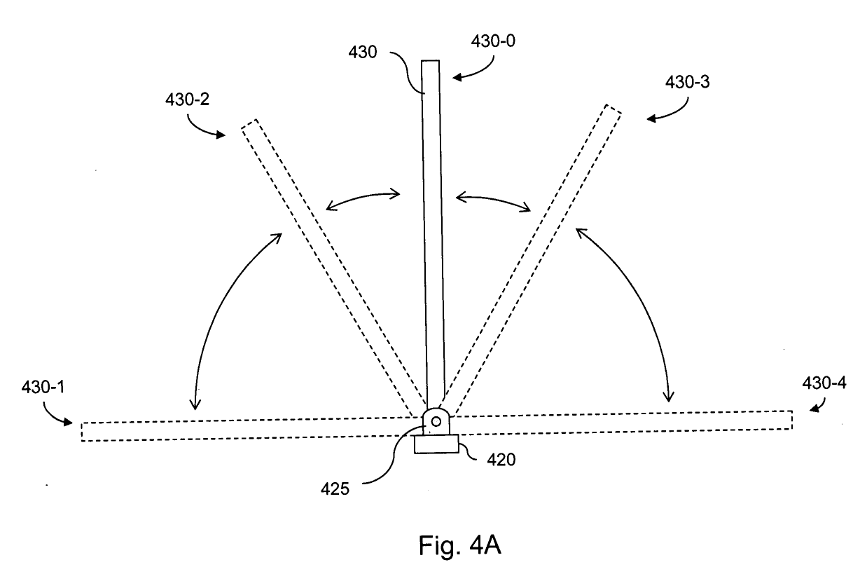

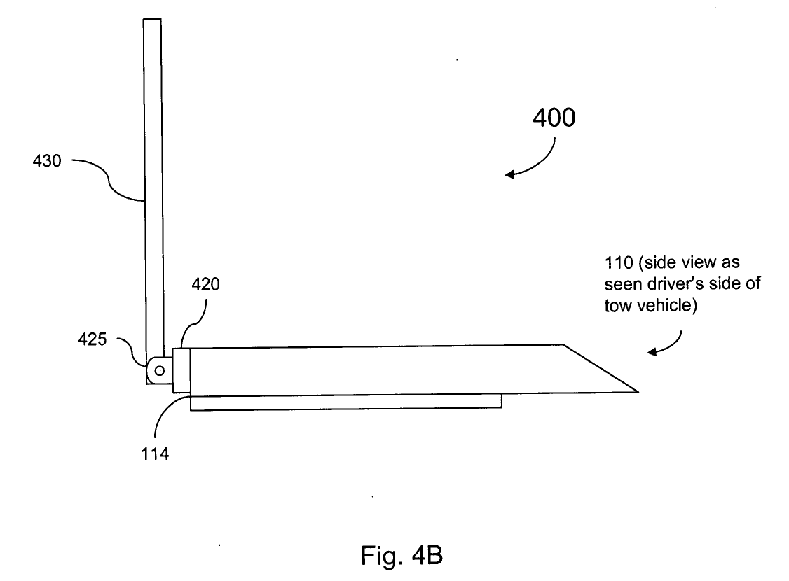

FIG. 4A illustrates one embodiment of an alternate alignment device 400 having a magnetic base section 420 comprising an angular adapter 425 adapted to secure mast section 430 to base section 420 at an angular orientation to base section 420, as illustrated generally by alternate mast section angular orientations 430-0, 430-1, 430-2, 430-3 and 430-4. In one embodiment, angular adapter 425 is adapted to allow for an adjustable angular orientation of mast section 430. In one embodiment, angular adapter 425 is adapted to allow mast section 430 to be angularly adjusted anywhere between +90 degrees (e.g. angular orientation 430-1) and −90 degrees (e.g. angular orientation 430-1). By providing for alternate mast section angular orientations, an alignment device 400 may be secured to receiving plate surface 113 of hitch receiver 110, as illustrated by alignment device 200 in FIGS. 1C and 2A. Alternatively, as illustrated in FIG. 4B, alignment device 400 may be secured to the back vertical portion 114 of hitch receiver 110 in order to hold mast section 430 in a viewable position.

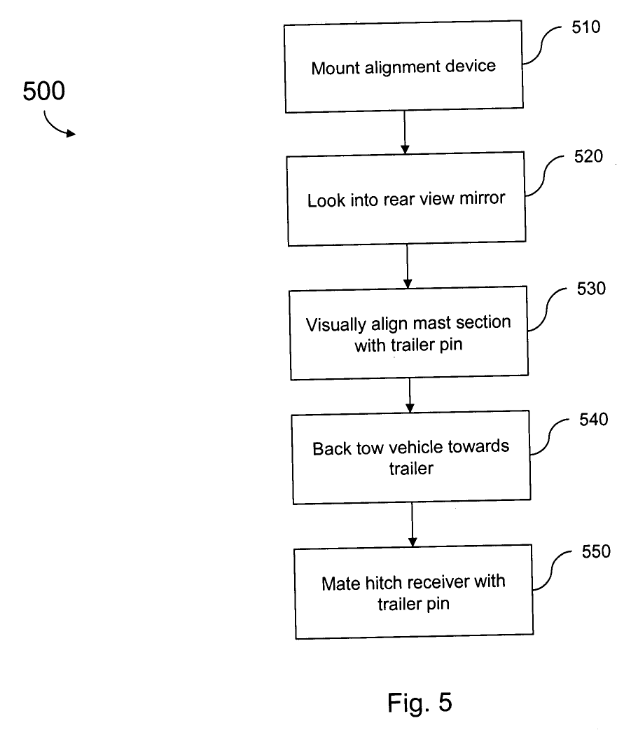

FIG. 5 is a flow chart of a method 500 of one embodiment for aligning a hitch receiver and pin using an alignment device of the present invention as illustrated in FIG. 1C. Embodiments of the present invention enable the driver to maneuver the tow vehicle to the precise location where the hitch receiver will mate with the fifth wheel pin assembly. Alignment device 200 is designed to be seen in the overhead rear view mirror 104 of tow vehicle 100 and act as a visual cue to the driver 105 while backing tow vehicle 100 towards trailer 120. By visually aligning mast section 230 with pin 150 (indicated by line-of-site 180), driver 105 can make adjustments to the relationship of tow vehicle 100 to trailer 120 and thereby more easily arrive at the precise location where the hitch receiver 110 will mate with pin 150. Method 500 first comprises mounting an alignment device onto a tow vehicle (510). In one embodiment, alignment device 200 is mounted on the tow vehicle cab 103 side of hitch receiver 110, approximately centered between the driver's side 111 and passenger side 112 of hitch receiver 110 (shown generally at 190). In one embodiment, alignment device 200 is mounted on the surface of cargo bed 102 between the tow vehicle cab 103 and hitch receiver 110 and approximately centered between the driver's side 107 and passenger side 106 of tow vehicle 100 (shown generally at 192). The exact position for placement of the device in relationship to the hitch receiver or tow vehicle can be readily determined by the user upon reading this specification. Method 500 continues with the driver of the tow vehicle looking into the rear view mirror (520) and aligning the mast section of the alignment device with the trailer pin (530) while backing the tow vehicle towards the trailer (540). The mast section acts to provide a visual cue to the driver while backing the tow vehicle towards the trailer. While visually aligning the mast section with the trailer pin through the rear view mirror, the driver adjusts the relative position of the tow vehicle with respect to the trailer, backing the tow vehicle towards the trailer until the tow vehicle hitch receiver mates with the trailer pin (550). Embodiments of the present invention enable the driver to maneuver the tow vehicle to the precise location where the hitch receiver will mate with the fifth wheel pin assembly.

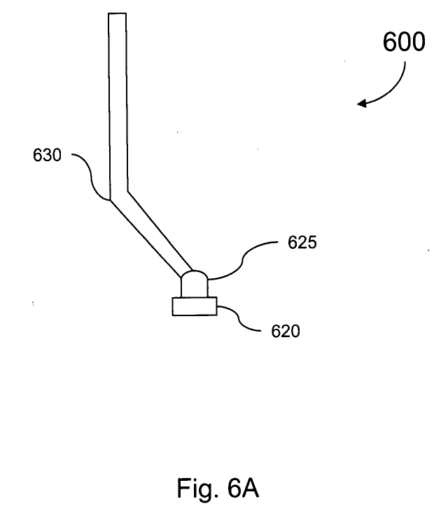

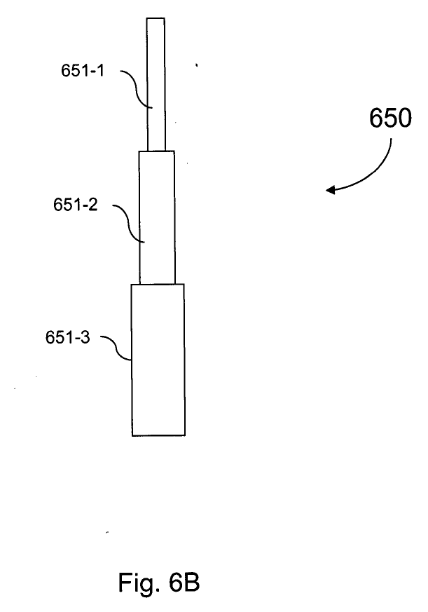

Although examples of embodiments presented in this specification included cylindrical mast sections, and mast sections constructed from commercially available PVC or CPVC waterline and waterline fittings material, embodiments of the present invention are not limited to the material or the cylindrical shape described by these examples. In other embodiments, an alignment device may comprise a mast section manufactured from one or more alternate materials including, but not limited to, plastics, woods, metals, and composite material. In other embodiments, an alignment device may comprise a mast section having a shape including, but not limited to a triangular, square, semi-cylindrical, or other poly-sided or curved shape. As illustrated in FIG. 6A, in one embodiment, and alignment device 600 may comprise an offset mast section 630. In one embodiment, the offset mast section 630 is secured to a base section 620 by an angular adapter 625. Further, as previously discussed, the choice of the exact length for a mast section may be based on the user's specific needs. This application is also intended to cover a mast section having adjustable lengths to aid a user in placing the mast section in a viewable position. As illustrated in FIG. 6B, in one embodiment, a mast section 650 comprises a plurality of telescoping sections (e.g. sections 651-1, 651-2, 651-3) which allow a user to adjust the overall length of mast section 650.

Additionally, although example embodiments presented in this specification focused on tow vehicles adapted with fifth-wheel hitch system, embodiments are not limited to fifth-wheel hitch systems but include other embodiments where the operator of a tow vehicle must visually align a tow vehicle mounted hitch with a trailer mounted hitch pin in order to couple the trailer to the tow vehicle.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

What is claimed is:

1. A device to aid the aligning and coupling of a tow vehicle having a trailer hitch receiver, to a trailer having a hitch pin compatible for use with the trailer hitch receiver, the device comprising:
a positionable base section; and
a mast section having an aligning end and a mounting end, wherein the mounting end is secured to the positionable base section, wherein the positionable base section is adapted to support the aligning end in a viewable position when the device is positioned on the tow vehicle.

2. The device of claim 1, wherein the positionable base section is adapted to support the mast section in an angular orientation approximately perpendicular with respect to a receiving plate surface of the trailer hitch receiver.

3. The device of claim 1, wherein the one or both of the mounting end and the positionable base section are further adapted to be secured together by one or more of a fastener, a screw, a nut, a bolt, a pin, and a threaded stud.

4. The device of claim 1, further comprising:
an angular adapter adapted to secure the mounting end of the mast section to the positionable base section, wherein the angular adapter is adapted to allow the angular orientation of the mast section to be adjusted.

5. The device of claim 1, the positionable base section further comprising:
magnetic material adapted to secure the mounting end of the mast section to metallic parts of one or more of the trailer hitch receiver and the tow vehicle.

6. The device of claim 1, wherein the mast section is adapted to be readily discernable against a background.

7. The device of claim 6, wherein the mast section is adapted to be readily discernable against the background by further comprising one or more of high visibility paint, high visibility tape, and brightly colored plastics.

8. The device of claim 1, wherein the aligning end is adapted to shed water.

9. A method for aligning a tow vehicle having a trailer hitch receiver, to a trailer having a hitch pin compatible for use with the trailer hitch receiver, the method comprising:
mounting an alignment device to the tow vehicle;
observing the alignment of a mast section of the alignment device with the hitch pin;
visually aligning the mast section of the alignment device with the hitch pin; and
adjusting the relative position of the tow vehicle with respect to the trailer while backing the tow vehicle towards the trailer to keep the mast section aligned with the hitch pin.

10. The method of claim 9, further comprising:
visually aligning the mast section of the alignment device with the hitch pin while looking into a rear view mirror of the tow vehicle.

11. The method of claim 9, further comprising:
backing the tow vehicle towards the trailer until the tow vehicle hitch receiver mates with the trailer pin.

12. The method of claim 9, wherein the tow vehicle includes a drivers side and a passengers side, the method further comprising:
mounting the alignment device to the hitch receiver approximately centered between the drivers side and the passenger side of the tow vehicle.

13. The method of claim 9, wherein the tow vehicle includes a cab and a cargo bed, the method further comprising:
mounting the alignment device to a floor of the cargo bed between the tow vehicle cab and the hitch receiver, and approximately centered between the drivers side and passenger side of the tow vehicle.

14. A tow vehicle adapted to be coupled with a trailer, the vehicle comprising:
means for coupling the tow vehicle to the trailer;
means for visually aligning the means for coupling the tow vehicle to the trailer with a means for coupling the trailer to the tow vehicle, wherein the means for visually aligning includes an aligning end and a mounting end; and
means for securing the mounting end of the means for visually aligning, wherein the means for securing is adapted to support the aligning end of the means for visually aligning in a position viewable from the rear view mirror of the tow vehicle.

15. The tow vehicle of claim 14, wherein the means for visually aligning is adapted to be secured to the means for securing by one or more of a fastening means, a screw means, a nut means, a bolt means, a pin means, and a threaded stud means.

16. The tow vehicle of claim 14 further comprising:
means for adjusting the angular orientation of the means for visually aligning with respect to the means for securing.

17. The tow vehicle of claim 14, the means for securing further comprising:
means for magnetically securing the mounting end of the means for visually aligning to metallic parts of one or more of means for coupling the tow vehicle to the trailer and the tow vehicle.

18. The tow vehicle of claim 14, further comprising:
means for making the means for visually aligning readily discernable against a background.

19. The tow vehicle of claim 18, wherein means for making the means for visually aligning readily discernable further comprises one or more of high visibility paint, high visibility tape, and brightly colored plastics.

20. The tow vehicle of claim 14, wherein the aligning end of the means for visually aligning is adapted to shed water.
